(19) United States
(12) Patent Application Publication
(10) Pub. No.: US 2026/0218550 A1
(43) Pub. Date: Jul. 30, 2026

(54) IMPROVED CELL FLANGE FOR A SEALED TRANSFER SYSTEM

(71) Applicant: GETINGE LIFE SCIENCE FRANCE SAS, Vendôme (FR)

(72) Inventor: Jean BELIN, LUNAY (FR)

(21) Appl. No.: 19/149,788

(22) PCT Filed: Jan. 24, 2024
(86) PCT No.: PCT/EP2024/051666

§ 371 Date: Jul. 21, 2025

(30) Foreign Application Priority Data
Jan. 25, 2023 (FR) FR2300670

(51) Int. Cl. E05C 3/04; F16L 37/248

(52) U.S. Cl. CPC E05C 3/041; F16L 37/248

(57) ABSTRACT

A cell flange comprising an annular flange body having a main axis and provided with means for fastening it to a wall of a cell, the flange body defining an internal passage, the cell flange having a cell door capable of selectively closing the internal passage, the cell flange also comprising a ring mounted in rotation relative to the flange body about the main axis and comprising a set of external lugs which project radially from an inner periphery of the ring and which are capable of forming an external bayonet connection, the cell door comprising a fixed portion and a movable portion which are mounted concentrically in rotation with respect to one another about the main axis, the movable portion comprising a set of internal lugs capable of forming an internal bayonet connection.

### CROSS REFERENCE TO RELATED APPLICATIONS

The present application is a U.S. National Phase of International Application No. PCT/EP2024/051666 entitled “IMPROVED CELL FLANGE FOR A SEALED TRANSFER SYSTEM”, and filed on Jan. 24, 2024. International Application No. PCT/EP2024/051666 claims priority to French Patent Application No. FR2300670 filed on Jan. 25, 2023. The entire contents of each of the above-listed applications are hereby incorporated by reference for all purposes.

### TECHNICAL FIELD

The invention relates to the tight transfer of objects from a tight container to a cell, with a double-door connection system.

### PRIOR ART

In various industrial sectors, tasks are performed in a confined atmosphere, to protect the environment for example from radioactivity or toxicity, or to perform these tasks in an aseptic atmosphere.

The transfer of objects from a container to a cell, without breaking the tightness, is carried out with a double-door connection device, known for example from documents FR2695343 and U.S. Pat. No. 8,950,624.

Such a device can be used for packaging medicinal products: a filling line is then installed in the cell, and small-sized objects such as vial caps are transferred into the cell to supply this line.

The cell is equipped with an annular cell flange of main axis which defines an inner passage sealed from the inside by a door mounted on a hinge equipping this flange, and the container is for example a bag wherein the opening is provided with a container flange equipped with another door.

The connection consists of engaging the flange of the container in that of the cell, and in pivoting it on itself, which has the effect of:
connecting the two flanges to each other by engaging a first bayonet connection or flange-flange connection;
connecting the two doors to each other by engaging a second bayonet connection or door-door connection;
disconnecting the door of the container from the flange thereof by disengaging a third bayonet connection or flange-door connection.

After connection, the cell door is pivoted inwards to open it: the door of the container then being rigidly connected to that of the cell by the door-door connection, it is carried with the cell door to remove it from the container flange.

When the objects have been transferred, the cell door can then be folded back against this opening with the container door borne thereby.

The container is then pivoted on itself in the opposite direction, which has the effect of:
securing the container door to the container flange;
disconnecting the container door from the cell door;
disconnecting the container door from the cell flange.

The connection operations require that a rotation of the container flange be performed about the main axis, which poses several problems. When the container is a flexible bag, the operation must support and handle the bag contents so that they follow the rotation of the flange. The bag contents can then, during this movement, damage the bag. When the operator does not handle the bag contents properly, a “bulge” is formed on the bag in the vicinity of the container flange and can damage the bag. In addition, with such a flange system, it is impossible to supply the cell with delicate or fragile objects using bags. Such objects are then stored in containers provided with inner cradles which uncouple the rotation of the cradle and the container about the main axis. Such devices are costly, subject to faults and greatly reduce the storage volume available in the container, then necessitating an increase in the number of connection/disconnection sequences of a container to the cell, which then increases the risks of a connection fault.

The aim of the invention is to enhance the reliability of a connection of a cell to a container using a double-door bayonet system.

### DISCLOSURE OF THE INVENTION

To this end, a cell flange is provided, comprising an annular flange body of main axis and which is provided with means for the attachment thereof to a wall of a cell, the flange body defining an inner passage, the cell flange having a door capable of selectively sealing the inner passage. According to the invention, the cell flange also comprises a ring rotatably mounted relative to the flange body about the main axis and which comprises a set of outer lugs which project radially from the inner periphery of the ring and which are capable of forming an outer bayonet connection. The door comprises a fixed portion and a movable portion concentrically rotatably mounted in relation to one another about the main axis, the movable portion comprising a set of inner lugs capable of forming an inner bayonet connection.

Thus, a cell flange is obtained which makes it possible to reduce the amplitude of a rotation of the container by connecting the outer bayonet connection by a rotation of the flange and not of the container. By reducing, even removing, the rotation of the container relative to the cell flange, the general reliability of the connection is enhanced.

According to specific, non-exclusive and optional embodiments of the invention:
the fixed portion is an annular portion which defines an inner recess for receiving the movable portion.
the movable portion also comprises means for locking the door to the flange.
the means for locking the door to the flange comprise a bolt rigidly connected to the movable portion and the flange comprises a catch.
the door comprises a device for rotatable coupling, separate from the inner bayonet connection, to transmit a rotation of the movable portion.
the flange comprises a portion actuator for actuating the rotation of the movable portion relative to the fixed portion and/or an opening actuator for selectively moving the door between an inner passage sealing position and an inner passage release position.
the flange comprises holding means intended to hold a container presented in front of the flange in position.
   the ring comprises a device for rotatably connecting with the movable door portion, the connecting device is arranged to selectively adopt a first coupled state in which the ring is rigidly connected to the movable door portion for rotation therewith, and a second uncoupled state in which the movable door portion is free to rotate relative to the ring, the rotatable-connection device being arranged to be in the first coupled state when the cell door completely seals off the inner passage, and to be in the second uncoupled state when the cell door at least partially opens the inner passage.
   the set of inner lugs comprises at least one stop protruding from an outer face of the movable door portion.

Further features and advantages of the invention will become apparent on reading the following description of specific non-limiting embodiments of the invention.

### BRIEF DESCRIPTION OF THE DRAWINGS

The invention will be better understood on reading the following description, given by way of non-limiting example, and made with reference to the figures which represent:

FIG. 1 is a schematic sectional view of a cell provided with a flange according to a first embodiment of the invention;

FIG. 2 is a schematic front view of the flange of FIG. 1, the door of which is shown closed;

FIG. 3 is a schematic half-sectional view of the flange of FIG. 1 and a container flange;

FIG. 4 is a schematic exploded perspective view of a container flange and a container door;

FIG. 5 is a schematic sectional view of the flange and the container door of FIG. 4;

FIG. 6 is a schematic partial perspective view of the flange and the container door of FIG. 5;

FIG. 7 is a schematic perspective view of a first step of connecting a container flange equipped with a door to a cell flange according to the invention;

FIG. 8 is a schematic front view of a second step of connecting a container flange equipped with a door to a cell flange according to the invention;

FIG. 9 is a schematic front view of a third step of connecting a container flange equipped with a door to a cell flange according to the invention;

FIG. 10 is a schematic perspective view of a fourth step of connecting a container flange equipped with a door to a cell flange according to a first embodiment of the invention;

FIG. 11 is a schematic front view of a fifth step of connecting a container flange equipped with a door to a cell flange according to a first embodiment of the invention;

FIG. 12 is a schematic perspective view of a sixth step of connecting a container flange equipped with a door to a cell flange according to a first embodiment of the invention;

FIG. 13 is a schematic sectional view of a cell flange according to a fifth embodiment of the invention;

FIG. 14 is a schematic perspective view of the cell flange of FIG. 13 facing which a container is presented;

FIG. 15 is a schematic front view of the flange of FIG. 13, the locking system whereof is shown in its closed state;

FIG. 16 is a schematic front view of the flange of FIG. 13, the locking system whereof is shown its open state;

FIG. 17 is a schematic cutaway perspective view of the flange of FIG. 13 connected to a container;

FIG. 18 is a schematic perspective view of the entirety of FIG. 17 when the cell door opens up the inner passage;

FIG. 19 is a schematic perspective view of a cell provided with a flange according to a sixth embodiment of the invention;

FIG. 20 is a schematic detail view of the cell flange of FIG. 19.

### DETAILED DISCLOSURE OF SPECIFIC EMBODIMENTS

With reference to FIGS. 1 to 3, a wall 100 of a cell not shown is equipped with a cell flange 200. This cell flange 200 has an inner face 4 facing the inside of the cell which it equips, and an outer face 7 facing the outside of the cell which it equips.

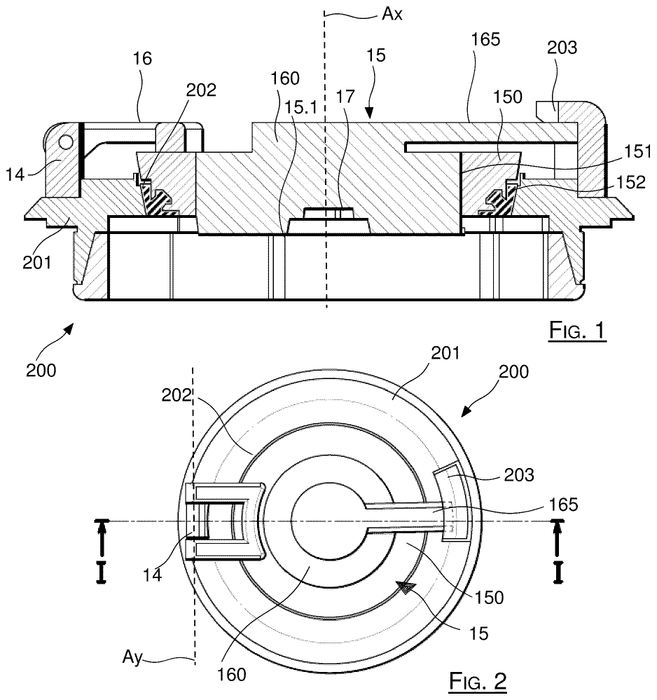

The cell flange 200 comprises an annular flange body 201 of main axis AX and which is provided with the means for the attachment thereof to the wall 100. The flange body 201 defines an inner passage 202. The flange 200 has a cell door 15 capable of selectively sealing the inner passage 202. The cell flange 200 is provided on the inside of the cell with a hinge 14 whereon the cell door 15 is mounted. The cell door 15 per se is connected to the hinge 14 via an arm 16 having a first end rigidly connected to the rotary element of the hinge 14, a body attached to the door. The cell door 15 also comprises a first square parallelepipedal impression 17 which is recessed from the face 15.1 of the cell door 15. The cell door 15 opens towards the inside of the cell to release the inner passage 202 of the flange 200, as in the configuration of FIG. 12. The cell door 15 can also occupy a position folded back onto the inner passage 202 to seal it, which corresponds to the configuration of FIGS. 1 and 2. As seen in FIGS. 1 and 2, the hinge 14 extends along an axis AY which is parallel with the wall 100 and which is here vertically oriented.

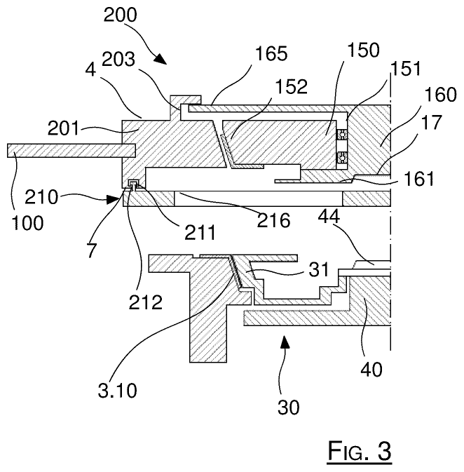

As seen in FIG. 3, the cell flange 200 comprises a ring 210 rotatably mounted relative to the flange body 201 about the axis AX. The guidance in rotation of the ring 210 on the flange 200 is, here, carried out by a circular slide rail 211 of axis AX. The ring 210 comprises a set of four outer lugs 212 to 215 which project radially from the inner periphery 216 of the ring 210 and which are capable of forming an outer bayonet connection, also referred to as flange-flange connection.

As seen in FIGS. 1 to 3, the cell door 15 comprises an annular fixed portion 150 which defines an inner recess 151 for receiving a movable portion 160. The fixed 150 and movable 160 portions are concentrically rotatably mounted in relation to one another about the axis AX and the movable portion 160 comprises a set of inner lugs 161 to 164 capable of forming an inner bayonet connection. The fixed portion 150 comprises an annular double-lip seal 152.

As can be seen in FIG. 1, the recess 151 is a through-recess, i.e. it passes through the cell door 15 to connect the inside and the outside of the cell.

The body 201 comprises a catch 203 which projects from the inner face 4 and the movable portion 160 comprises a bolt 165 which extends radially overhanging from the fixed portion 150 to cooperate with the catch 203 by rotating about the axis AX.

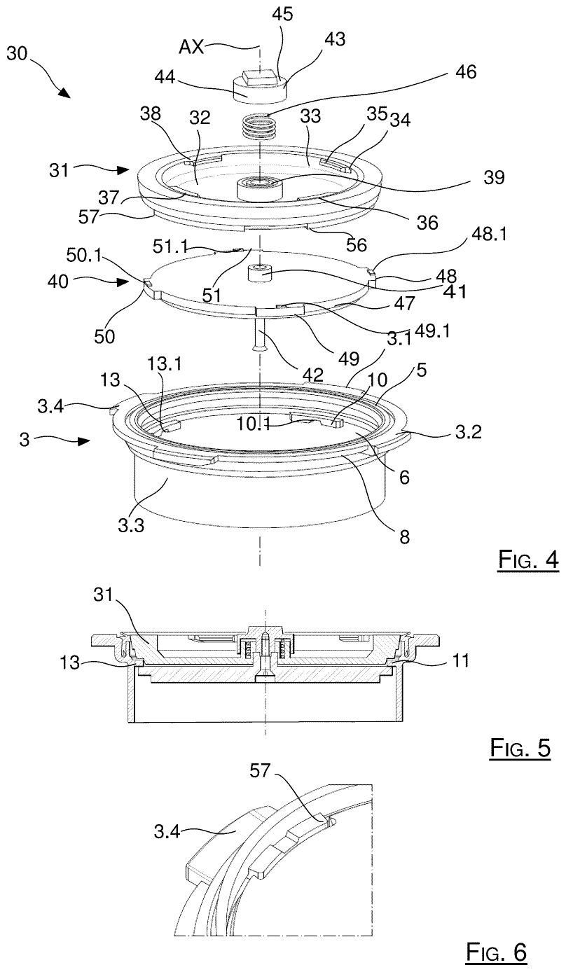

The container flange 3 is of annular shape and comprises a cylindrical inner face 5 which defines an inner passage 6. The inner passage 6 includes four inner tabs 10 to 13 regularly distributed about a central main axis AX of the container flange 3. Two of these inner tabs 10 and 13 are seen in FIG. 4, these inner tabs 10 to 13 project radially towards the axis AX. The face of the tab 10 facing the inner passage 6 comprises a truncated pyramid-shaped notch 10.1 which is recessed from said face. The inner tabs 11, 12 and 13 respectively comprise similar notches 11.1, 12.1 and 13.1. The container flange 3 comprises four container lugs 3.1 to 3.4 which project outwards from the outer face 8 of the container flange 3.

As seen in FIGS. 4 and 5, the container door 30 comprises a revolving cylindrical body 31 along the axis AX. The body 31 also defines a blind cylindrical recess 32 of axis AX and which is open at the front face 33 thereof. The recess 32 comprises a wall 34 with a radially projecting set of four inner tabs 35, 36, 37 and 38 capable of forming the inner bayonet connection with the inner lugs 161 to 164 of the cell door 15. The container flange 3 is provided with a container door 30 which rests on a double-lip seal 3.10.

The door 30 also comprises a plate 40 rotatably mounted about the axis AX relative to the body 31. For this purpose, the plate 40 comprises an axial cylindrical protrusion 41 which is received in a central cylindrical bearing 39 of the body 31. A screw 42, which extends through the protrusion 41 and the bearing 39, rotatably connects the plate 40 and a cap 43 located on the side of the front face 33 of the body 31. The cap 43 is provided at the top thereof with a second square parallelepipedal impression 44 which projects from a top face 45 of the cap 43. The second impression 44 is complementary with the first impression 17. A helical spring 46 inserted between the body 31 and the cap 43 returns the plate 40 to the body 31.

The plate 40 comprises projecting radially from the periphery 47 thereof a set of four door lugs 48, 49, 50 and 51 capable of forming a bayonet door connection with the inner tabs 10 to 13. As seen in FIG. 4, the face of the door lug 48 facing the body 31 comprises a truncated pyramid-shaped dog point 48.1 which projects axially from said face. The door lugs 49, 50 and 51 respectively comprise similar dog points 49.1, 50.1 and 51.1.

The body 31 comprises four regularly distributed outer stops 55 to 58 projecting radially from the body 31 about the axis AX. Two of these outer stops 56 and 57 are seen in FIG. 4.

The outer stops 55 to 58 project radially from the circular outer perimeter of the body 31 to be able to each be engaged between two adjacent inner tabs 10 to 13 of the container flange 3 whereon they bear, as in the configuration of FIG. 6. The stops 55 to 58 thus lock a rotation about the axis AX of the body 31 relative to the container flange 3.

Optionally, a safety device not seen in the figures ensures that the bolt 165 can only be disengaged from the catch 203 when the cell flange 200-container flange 3 connection is engaged, and that it is locked in the locked position. It is thus not possible to open the cell door 15 without a container being connected by the container flange 3 thereof to the cell flange 200.

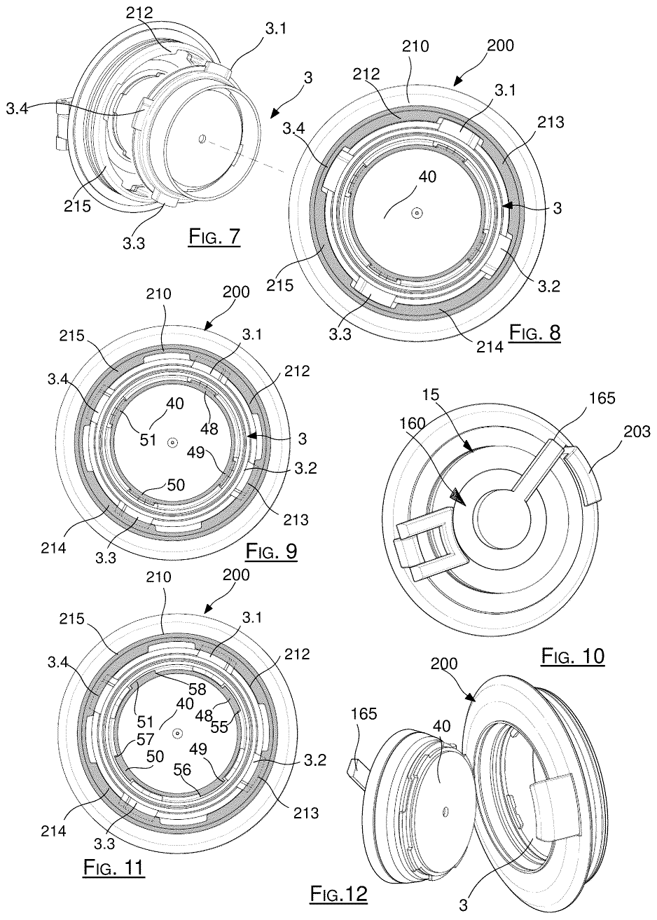

With reference to FIGS. 7 to 12, connecting the container flange 3 to the cell consists of engaging the container lugs 3.1 to 3.4 of the container flange 3 in the cell flange 200 so as to present the container lugs 3.1 to 3.4 of the container flange 3 between the outer lugs 212 to 215 of the ring 210 (FIGS. 7 and 8). The ring 210 is then pivoted about the axis AX—here a rotation of thirty degrees in the clockwise direction as represented in FIG. 9—to form the outer bayonet connection and connect the container 3 to the cell flange 200. During the operation of approaching the container flange 3 to the cell flange 200 (FIGS. 7 and 8), the second impression 44 of the cap 43 is received in the first impression 17 of the cell door 15, which rotatably couples the cell door 15 and the plate 40. When the container flange 3 is inserted in the cell flange 200, the bearing force applied by the cell door 15 on the cap 43 against the spring 46 induces a translation of the plate 40 relative to the body 31 along a parallel direction with the axis AX. The dog points 48.1, 49.1, 50.1 and 51.1 are respectively removed from the notches 10.1, 11.1, 12.1 and 13.1 and the plate 40 is then free to rotate relative to the body 31.

A rotation movement is then applied to the movable portion 160 (here a rotation of sixty degrees in the anti-clockwise direction as represented in FIGS. 2 and 10), and during this rotation movement, the following steps take place:
the inner lugs 161 to 164 of the cell door 15 cooperate with the inner tabs 35 to 38 of the container door 30 to engage the inner bayonet connection, also referred to as door-door connection and not shown in the figures. The inner bayonet connection connects the container door 30 to the cell door 15;
the second impression 44 engaged in the first impression 17 rotatably connects about the axis AX the movable portion 160 of the cell door 15 with the plate 40. The stops 55 to 58 in contact with the inner tabs 10 to 13 lock a rotation about the axis AX of the body 31 relative to the container flange 3. Thus, during the rotation movement of the movable portion 160 about the axis AX, the rotation of the movable portion 160 is transmitted to the plate 40 which performs a rotation about the axis AX relative to the body 31. This has the effect of bringing the lugs 48 to 51 to face the stops 55 to 58 and thus disengage the door bayonet connection, also referred to as flange-door connection. The container door 30 is then disconnected from the container flange 3 (FIG. 11);
rotating the movable portion 160 about the axis AX releases the bolt 165 from the catch 203 (FIG. 10).

Following these operations, the coupling of the container door 30 with the cell door 15 is completed and the cell door 15 is unlocked. Opening the cell door 15 makes it possible to free the inner passage 202 by carrying the container door 30 therewith, which corresponds to the scenario in FIG. 12.

In the same manner, when the transfer has been carried out, the cell door 15 is folded back before applying a rotation about the axis AX in the clockwise direction (as represented in FIGS. 2 and 10) to the movable portion 160. This has the effect of locking the door 15 on the flange 200, disengaging the inner bayonet connection—which disconnects the cell door 15 and the container door 30—and engaging the door bayonet connection—which connects the container door 30 to the container flange 3. Finally, by acting upon the ring 210 to impart a rotation in the anti-clockwise direction thereto, the outer bayonet connection is disengaged and the container flange 3 is uncoupled from the cell flange 200.

A cell flange 200 is thus obtained, the specific arrangement whereof avoids having to apply a rotation movement to the container to be able to connect it to the cell. Thus, by avoiding twisting flexible bags or the use of cradles rotatably mounted in a rigid container, the risks of connection fault of the container to the cell are reduced, which thus increases the reliability of the cell flange according to the invention with respect to existing flanges.

Identical or similar elements to those described above will bear an identical reference number to that in the following description of a second, third and fourth embodiment of the invention.

According to a second embodiment not shown, the flange 200 comprises a portion actuator for actuating the rotation of the movable portion 160 relative to the fixed portion 150. Such a portion actuator can take the form of a rotary gear motor placed between the fixed portion 150 and the movable portion 160. This portion actuator can also take the form of a linear actuator extending between the bolt 165 and the fixed portion 150.

According to a third embodiment not shown, the flange 200 comprises a door opening actuator 15 in the form of a motorisation of the hinge 14. Such a door opening actuator makes it possible to selectively move the door 15 between an inner passage 202 sealing position and an inner passage 202 release position without requiring an intervention from inside the cell.

According to a fourth embodiment not shown, the flange 200 comprises a holding cradle connected to the outer face 7 of the flange 200. This cradle is arranged to receive the container flange 3 and hold it in position during the step of rotating the ring 210.

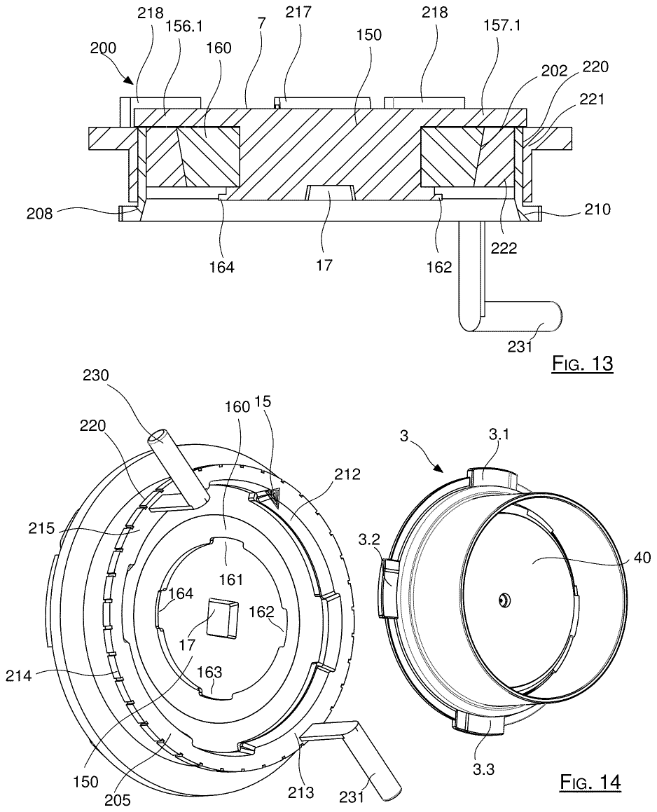

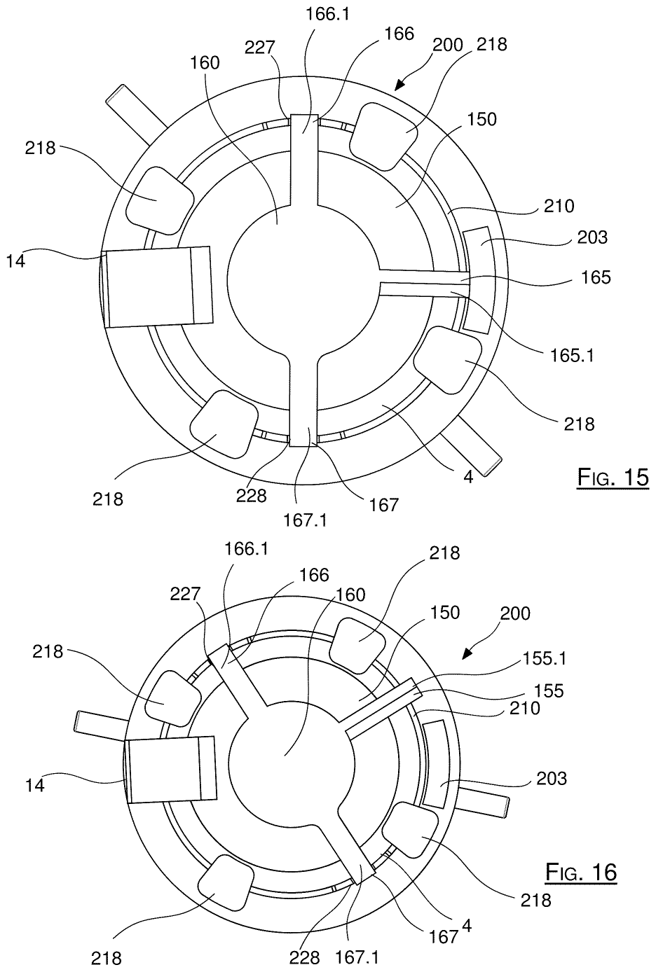

According to a fifth embodiment shown in FIGS. 13 to 18, the ring 210 comprises two handles 230 and 231 that extend outside the cell. The ring 210 is received in an annular recess 220 in the flange 200, which recess is defined by two concentric annular elements 221 and 222 of the flange 200 which are rigidly connected to each other by four arms 218 which lie flush with the inner face 4 of the flange 200. The ring 210 thus passes through the door 15.

As can be seen in FIG. 15, the portion of the ring 210 which projects from the inner face 4 of the cell flange 200 comprises two radial notches 227 and 228 which respectively receive diametrically opposed portions 166 and 167 which extend facing the inner face 4 of the flange 200 in radial directions from the movable portion 160 in the form of a first and a second arm 166.1 and 167.1. The bolt 165 is also rigidly connected to a third arm 165.1 which extends opposite the inner face 4 of the flange 200 in a radial direction from the movable portion 160.

During the operation of approaching the container flange 3 to the cell flange 200 (FIG. 15), the second impression 44 of the cap 43 is received in the first impression 17 of the movable portion 160 of the cell door 15, which rotatably couples the fixed portion 160 of the cell door 15 and the plate 40. When the container flange 3 is inserted in the cell flange 200, the bearing force applied by the cell door 15 on the cap 43 against the spring 46 induces a translation of the plate 40 relative to the body 31 along a parallel direction with the axis AX. The dog points 48.1, 49.1, 50.1 and 51.1 are respectively removed from the notches 10.1, 11.1, 12.1 and 13.1 of the inner tabs 10 to 13 and the plate 40 is then free to rotate relative to the body 31.

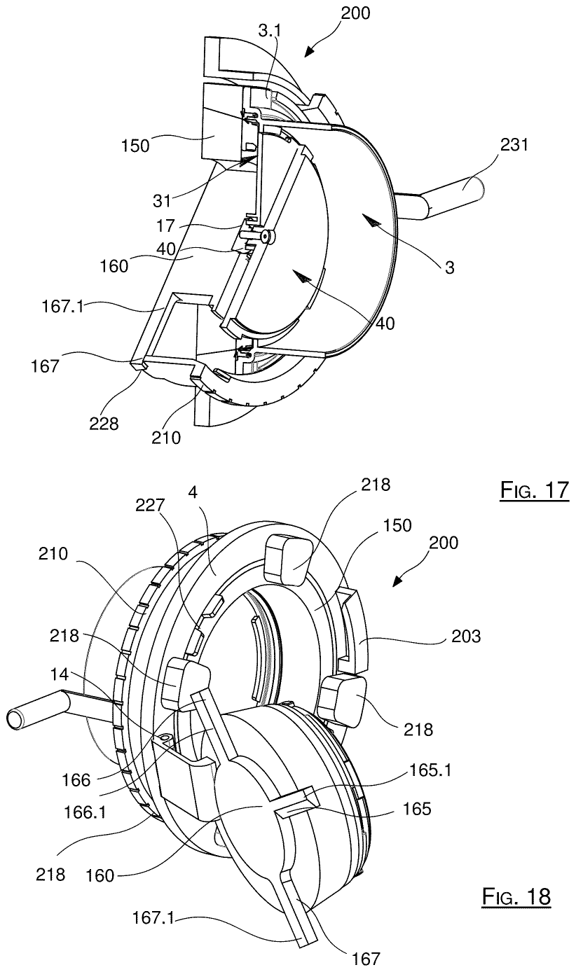

The ring 210 is then pivoted, using the handles 230 and 231, about the axis AX here a rotation of thirty degrees in the clockwise direction as represented in FIGS. 13 and 15 to form the outer bayonet connection and connect the container 3 to the cell flange 200, and during this rotational motion, the following steps take place:
the second impression 44 engaged in the first impression 17 rotatably connects about the axis AX the movable portion 160 of the cell door 15 with the plate 40. The stops 55 to 58 in contact with the inner tabs 10 to 13 lock a rotation about the axis AX of the body 31 relative to the container flange 3. The rotational motion of the ring 210 about the axis AX is transmitted via the notches 227 and 228 to the movable portion 160. The rotation of the movable portion 160 then causes the plate 40 to rotate about the axis Ax. The inner tabs 10 to 13 remain immobile and the plate 40 rotates about the axis AX by thirty degrees relative to the door lugs 48 to 51. This has the effect of bringing the lugs 48 to 51 to face the stops 55 to 58 and thus disengage the door bayonet connection, also referred to as flange-door connection. The container door 30 is then disconnected from the container flange 3;
during the rotation of the ring 210 relative to the door 15, the inner lugs 161 to 164 of the movable portion 160 of the cell door 15 connect with the inner tabs 35 to 38 of the container door 30 to engage the inner bayonet connection, also referred to as door-door connection and not shown in the figures. The inner bayonet connection rigidly connects the container door 30 to the cell door 15 (FIG. 18);
the rotation of the ring 210 also causes the grooves 212 to 215 to rotate about the axis Ax relative to the container 3 which causes the container lugs 3.1 to 3.4 to engage in the grooves 212 and 215 and thus form the outer bayonet connection, also referred to as the flange-flange connection between the container 3 and the cell flange 200 (FIG. 18);
the rotation of the ring 210 is transmitted via the notches 227 and 228 to the movable portion 160. Rotating the movable portion 160 about the axis Ax releases the bolt 165 from the catch 203 (FIG. 16). The locking means consisting of the bolt 165 and the catch 203 then switch to a door 15 unlocking state (FIG. 16).

Following these operations, the coupling of the container door 30 with the cell door 15 is completed and the cell door 15 is unlocked. Opening the cell door 15 makes it possible to free the inner passage 202 by carrying the container door 30 therewith, which corresponds to the scenario in FIG. 18. When the door 15 leaves its closed position in which it completely closes the passage 202 (shown in FIG. 16) to at least partially release the passage 202, the portions 166 and 167 of the movable portion 160 respectively disengage from the notches 227 and 228 and the movable portion 160 is free to rotate relative to the ring 210 (FIG. 18).

In the same manner, when the transfer has been carried out, the cell door 15 is folded back before applying a rotation about the axis AX in the anti-clockwise direction (as represented in FIG. 15) to the ring 210 using the handles 230 and 231. This has the effect of locking the door 15 on the flange 200, disengaging the inner bayonet connection—which disconnects the cell door 15 and the container door 30—and engaging the door bayonet connection—which connects the container door 30 to the container flange 3. Finally, the external bayonet connection is disengaged and the container flange 3 is uncoupled from the cell flange 200.

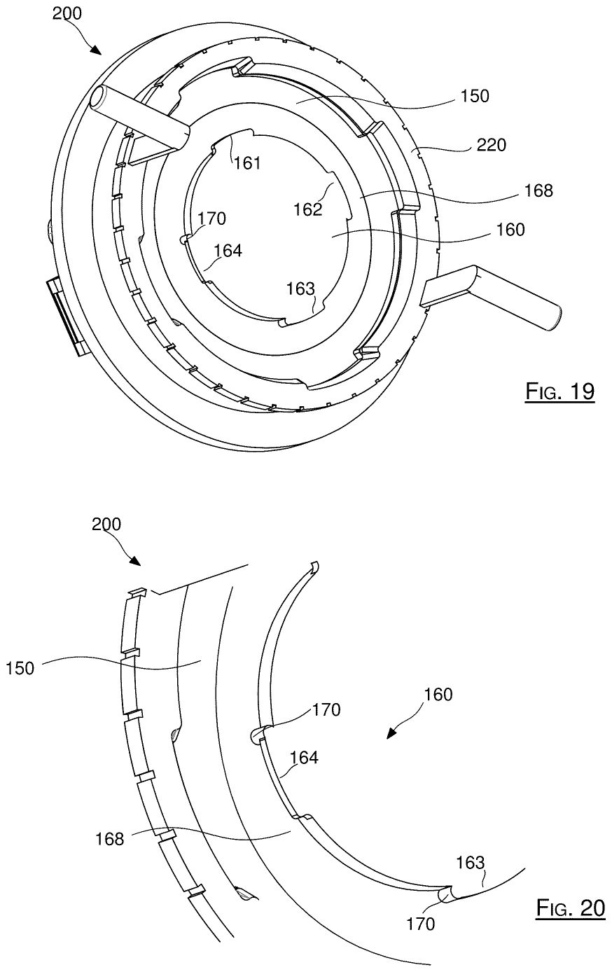

According to a sixth embodiment shown in FIGS. 19 and 20, the movable portion 160 is provided with an impression 17 and the inner lugs 161 to 164 comprise stops 170 which project from the outer face 7 of the flange 200 and more particularly from the outer face 168 of the movable portion 160.

According to this sixth embodiment, when connecting the cell flange 200 with a container 3 of a known type whose door 30 is devoid of any plate 40 and impression 44, the door 30 is uncoupled from the container 3 by rotating the door 30 relative to the container 3. This rotation is caused by the stops 170 coming to rest against the inner tabs 35, 36, 37 and 38 which then rotate the door 30 about the axis Ax to break the inner bayonet connection between the container door and the container flange.

Of course, the invention is not limited to the embodiments described but encompasses any alternative embodiment falling within the scope of the invention as defined by the claims.

In particular,
although here the impression is a parallelepiped of square cross-section, the invention also applies to other types of impression patterns such as for example other versions of a quadrilateral pattern such as a rectangle, a rhombus or any shape, the impression can also adopt a triangular or polygonal pattern, the impression optionally projecting or being recessed from the top face of the cap;
although here the coupling device comprises a square impression intended to cooperate with an equivalent impression of the container door, the invention also applies to other types of coupling devices accessible from the front face of the door body such as for example a device not requiring modification of the cell door and for which coupling is performed by friction via a friction disk mounted on the cap;
although here the outer lugs comprise truncated pyramid-shaped dog points, the invention also applies to other types of means for locking the flange-door connection such as for example cylindrical dog points or any other type of axially projecting protrusions or axially recessed parallelepipedal notches or of any shape;
although here the container comprises a helical spring, the invention also applies to other types of return means which can be elastic type return means such as for example an elastomer block, Belleville washers or a return means devoid of elastic element such as a magnet for example;
although here the outer lugs comprise truncated pyramid-shaped dog points, the invention also applies to other types of means for locking the flange-door connection such as for example cylindrical dog points or any other type of axially projecting protrusions or axially recessed parallelepipedal notches or of any shape;
although here the body comprises four outer stops, the invention also applies to other types for locking the body against rotation, such as for example a single stop;
although here the operations for connecting and disconnecting the container and the cell flange require a relative rotation of the container and the cell flange by an amplitude of sixty degrees, the invention also applies to other angular amplitude values such as for example an amplitude of thirty degrees;
although the flange here comprises a holding cradle, the invention also applies to other types of holding means intended to hold in position a container presented in front of the flange, such as for example magnets, a device for holding the container flange relative to the cell flange by a vacuum, or a device for clipping the container flange onto the cell flange;
although here the ring performs a rotation of thirty degrees to form the outer bayonet connection, the invention also applies to other amplitudes of rotation of the ring such as for example less than thirty degrees, sixty degrees or any value.
although here the container door comprises a removable plate and a device for rotatably coupling the plate, the invention also applies to the container connection wherein the container door is made of one piece, devoid of plate such as those known from the prior art;
although here a movable portion comprises a bolt, the invention also applies to other means for locking the door to the flange, such as for example a magnetic lock, a roller or a pin inserted into a bore;
although the outer flange comprises a set of four outer lugs, the invention also applies to a flange wherein the set of outer lugs comprises a different number of lugs such as two, three or more than four outer lugs;
although here the movable portion is located inside the fixed portion, the invention also applies to other types of configuration such as for example a movable portion located outside the fixed portion.

1. Cell flange comprising an annular flange body of main axis and which is provided with means for the attachment thereof to a wall of a cell, the flange body defining an inner passage, the cell flange having a cell door being capable of selectively sealing the inner passage, the cell flange also comprising a ring rotatably mounted relative to the flange body about the main axis and which comprises a set of outer lugs which project radially from an inner periphery of the ring and which are capable of forming an outer bayonet connection, the cell door comprising a fixed portion and a movable portion concentrically rotatably mounted in relation to one another about the main axis, the movable portion comprising a set of inner lugs capable of forming an inner bayonet connection,
wherein the fixed portion is an annular portion which defines an inner recess for receiving the movable portion.

2. Flange according to claim 1, wherein the movable portion also comprises locking means of the cell door to the flange.

3. Flange according to claim 2, wherein the locking means of the cell door to the flange comprise a bolt rigidly connected to the movable portion and the flange comprises a catch.

4. Flange according to claim 1, wherein the cell door comprises a rotatable-coupling device, separate from the inner bayonet connection, to transmit a rotation of the movable portion.

5. Flange according to claim 1, comprising a portion actuator for actuating the rotation of the movable portion relative to the fixed portion and/or an opening actuator for selectively moving the cell door between an inner passage sealing position and an inner passage release position.

6. Flange according to claim 1, comprising holding means intended to hold a container presented in front of the flange in position.

7. Flange according to claim 1, wherein the ring comprises a device for rotatably connecting with the movable door portion, the connecting device is arranged to selectively adopt a first coupled state in which the ring is rigidly connected to the movable door portion for rotation therewith, and a second uncoupled state in which the movable door portion is free to rotate relative to the ring, the rotatable-connection device being arranged to be in the first coupled state when the cell door completely seals off the inner passage, and to be in the second uncoupled state when the cell door at least partially opens the inner passage.

8. Flange according to claim 7, wherein the set of inner lugs comprises at least one stop protruding from an outer face of the movable door portion.
